(19) United States
(12) Patent Application Publication
(10) Pub. No.: US 2020/0387984 A1
(43) Pub. Date: Dec. 10, 2020

(54) METHOD AND AN APPARATUS FOR PRE-ORDERING OCCASION-BASED FOOD ITEMS

(71) Applicant: Monginis Foods Pvt Ltd, Mumbai (IN)

(72) Inventor: Qusai Zoher KHORAKIWALA, Mumbai (IN)

(21) Appl. No.: 16/432,973

(22) Filed: Jun. 6, 2019

(51) Int. Cl. G06Q 50/12; G06Q 30/06; G06Q 10/08

(52) U.S. Cl. CPC G06Q 50/12; G06Q 10/0838; G06Q 30/0631

(57) ABSTRACT

The present invention provides a method and an apparatus to allow the food ordering users to pre-order the food items on a significant day of the receiving user. The system comprises of a set of databases i.e. user database, food vendor database, food list database and significant day database; a set of modules i.e. occasion based recommendation module, graphic display module, food items module, food item list generator module, personal message module and packaging selection module and interface i.e. display interface. With this invention, the food ordering user gets the food recommendations based on the significant day or occasion-based recommendations.

### BACKGROUND OF THE INVENTION

The current online food ordering system environment includes members like ordering users, receiving users, food vendors, hospitality service providers, fashion products ordering platforms, FMCG, groceries and essential products ordering platforms and local travel booking platforms. Many online food ordering systems, and online food ordering food ordering mobile applications allow users to select food items from restaurant menus based on the location of the user and to get the ordered food delivered at the desired location. Recently, online food ordering system providers enable the live tracking of their food orders via a computer or mobile interface.

However, some online food ordering systems, especially those offering online food ordering through mobile applications may find it difficult to allow ordering of significant day based items by one set of users to another set of users present in the online food ordering system environment during the food ordering process, partly due to the fact that the current online food ordering system environment and its computer-implemented method or computer implemented interface adaptations like food ordering mobile applications do not have the ability to allow ordering users to place an order from a selection of occasion based food items and optional add-ons such as greeting cards, personal messages, or special packaging, or for order receiving users to receive aforementioned occasion based food items along with the optional add-ons.

There are some methods available for simplifying the process for the ordering user. U.S. Pat. No. 9,406,084 provides a method for submitting a food order remotely. In the method a graphical icon representative of a food item is generated and a customization option for the food item selected by a customer. The icon is associated with a payment option and with a store location to fulfill the food item. The icon is displayed on a display of a mobile computing device and in response to receiving a selection of the icon, submitting a food order including the food item, the customization option, and the payment option to the store location.

U.S. RE46731 discloses a computer-based ordering system for ordering goods and services includes a plurality of self-service client terminals and a server. Each self-service client terminal runs a self-order application including a set of interactive menu screens having buttons that allow the customer to select and customize products for the order. An administration tool application communicates with the server to administer the self-service client terminals. The administration tool application including a menu editor that enables the administrator to create and edit the interactive menu screens provided by the self-order application at the self-service client terminals. The menu editor accesses a library of menu templates containing predefined groupings of buttons, and uses the menu templates, as directed by the administrator, during creation and editing of the interactive menu screen.

A user is restricted from pre-ordering food items based on significant days. The user is further restricted from including occasion-specific greeting cards and personal messages along with the food order for the food receiving user. The user is further restricted from ordering food as a gift which would be delivered to the food receiving user on a specific occasion of the food receiving user.

### SUMMARY OF THE INVENTION

The present invention specifically relates to allowing the food ordering users to pre-order the food items on a significant day of the receiving user.

Another aspect of the present invention is that the food ordering user can choose to add significant day based personal messages, greeting cards, and packaging with their preorder of food items.

Yet another aspect of the present invention is that the food items can be preordered within a time-limited pre-booking slot unique to each type of significant day.

Other objects and advantages of the present invention will become apparent from the following description taken in connection with the accompanying drawings, wherein, by way of illustration and example, the aspects of the present invention are disclosed.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 is a block diagram of the metadata of a food ordering system 100 according to one embodiment.

FIG. 2 is a block diagram of an occasion based recommendation module 110 according to one embodiment.

FIG. 3 is a flow diagram of the method for pre-ordering occasion based food items in a food ordering system according to one embodiment.

FIG. 4 illustrates modules of an example machine 400 able to read instructions from a machine-readable medium and execute them in a processor (or controller) according to one embodiment according to one embodiment.

### DETAILED DESCRIPTION OF THE INVENTION

The following description describes various features and functions of the disclosed method and apparatus with reference to the accompanying figures. In the figures, similar symbols identify similar components, unless context dictates otherwise. The illustrative aspects described herein are not meant to be limiting.

These and other features and advantages of the present invention may be incorporated into certain embodiments of the invention and will become more fully apparent from the following description and claims or may be learned by the practice of the invention as set forth hereinafter. It may be readily understood that certain aspects of the disclosed method and apparatus can be arranged and combined in a wide variety of different configurations, all of which are contemplated herein.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention are provided for illustration purpose only and not for the purpose of limiting the invention.

It is to be understood that the singular forms “a,” “an,” and “the” include plural referents unless the context clearly dictates otherwise.

It should be emphasized that the term “comprises/comprising” when used in this specification is taken to specify the presence of stated features, integers, steps or components but does not preclude the presence or addition of one or more other features, integers, steps, components or groups thereof.

The Figures (FIGS.) and the following description relate to embodiments by way of illustration only. It should be noted that from the following discussion, alternative embodiments of the systems, methods, figures, diagrams and interfaces disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the systems, methods, figures, diagrams and interfaces illustrated herein may be employed without departing from the principles described herein. In the following description, for the purposes of explanation, numerous specific details are set forth in order to provide a thorough understanding of the various embodiments. It will be evident, however to one skilled in the art that the various embodiments may be practiced without these specific details.

### Configuration Overview

A method for significant day or occasion based pre-ordering of food items in a food ordering system is provided. The occasion based recommendation module in the food ordering system may comprise a plurality of modules and generators such as but not limited to a food item ordering module, a pre-booking slot generator, a food item listings module, a food items list generator, a personal message preference module, a packaging selection preference module, and a greeting card preference module. The method for significant day or occasion based pre-ordering of food items in a food ordering system may comprise a plurality of steps like receiving a food ordering request from an ordering user, generating a set of unique time-limited pre-booking slots, determining at least one compatible occasion based food item listing from a set of predefined food item listings, generating at least one such food items list, and displaying a plurality of compatible occasion based food items.

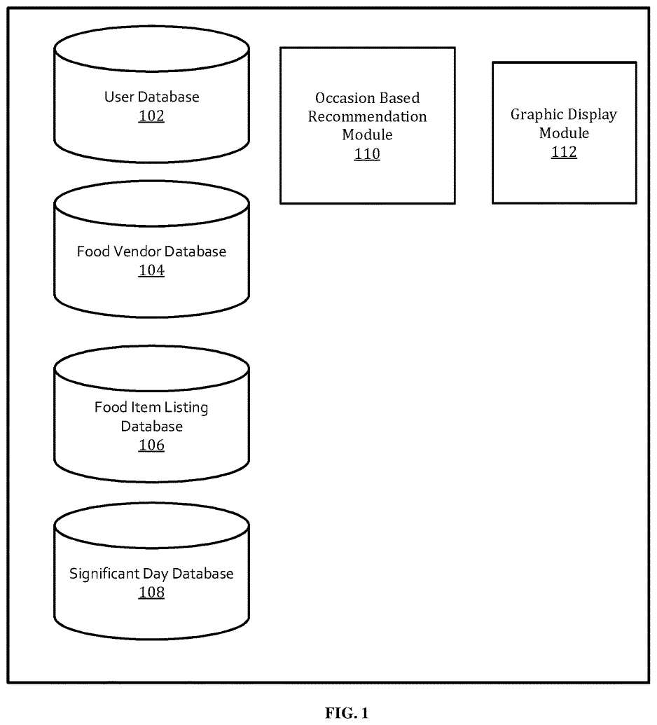

FIG. 1 is a block diagram of a food ordering system 100 according to one embodiment. The food ordering system 100 includes a variety of databases and modules for providing significant day-based pre-ordering of food items to users of the food ordering system 100. The occasion-based pre-ordered food items are made available to users using the occasion-based recommendation module. Additional modules of the food ordering system 100 are described below.

The user database 102 may maintain information about each type of user based on the user's role in the system. The user information may be stored in a plurality of databases, each database associated with a user role, or the user roles may be stored in a single user database 102. For example, the additional user roles include ordering users, vending users, receiving users, and other types of users of the food ordering system 100.

A user database 102 is further configured for receiving, storing, updating and retrieving a plurality of data fields of each user, such as the user's name, address, and contact details. Depending on the user's role in the food ordering system 100, the user database 102 maintains additional information on the user. For example, for an exemplary ordering user, the user database 102 maintains ordering history in the food ordering system 100.

In one embodiment, a distinct food vendor database 104 is configured for receiving, storing, updating and retrieving a plurality of data fields of each food vendor, comprising the name of the restaurant, location, special offers and discounts, delivery timings, preferences and/or criteria if any, along with payment mode.

In one embodiment, a distinct food item listing database 106 is configured for receiving, storing, updating and retrieving a plurality of data fields of each food item listing, comprising the details of food items offered by each restaurants, specialty of the restaurant and availability of the food item, significant day relevance, and other such associated details. For example, in some embodiments, an eggless cake may be listed as a vegetarian birthday food item.

In one embodiment, a distinct significant day database 108 is configured for receiving, storing, updating and retrieving a plurality of data fields of each significant day, comprising a list of occasions and the associated food items.

An occasion based recommendation module 110 is configured for recommending relevant food item listings based on the food request received by the exemplary ordering user. In some embodiments, the food and associated food item recommendations generated by the occasion based recommendation module 110 for the occasion of an anniversary may be a personalized cake, wine, a flower bouquet, and favorite food as per user preference or selection. The occasion based recommendation module 110 may also generate a list of food items relevant to the occasion which are the restaurant specialty to allow the exemplary ordering user to order those items.

A graphic display module 112 is configured for displaying food item recommendations, personal message preferences, greeting card preferences, packaging selection preferences and other such graphical user interface elements.

In one embodiment, the user database 102, food vendor database 104, food items listing database 106, significant day database 108 and other databases form a single consolidated database in the food ordering system 100.

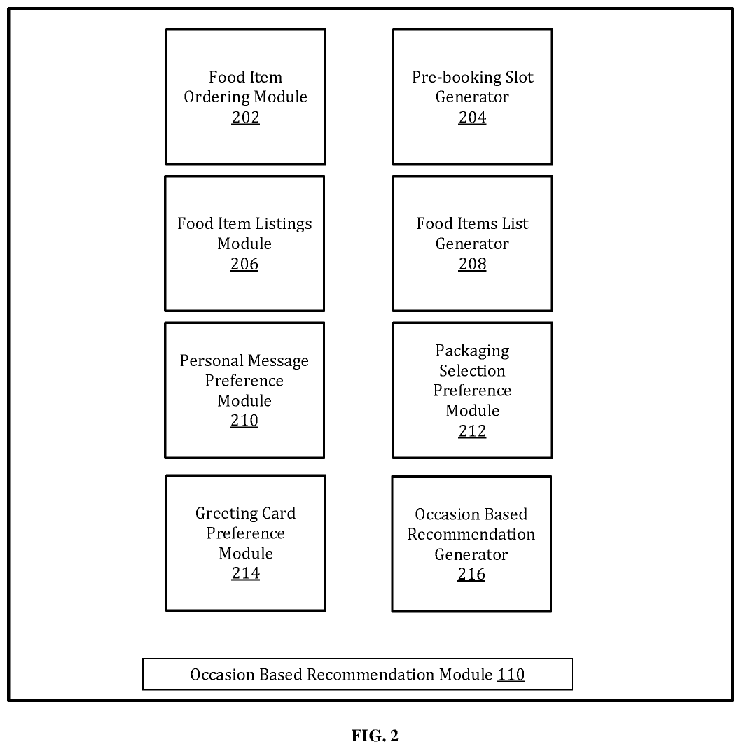

FIG. 2 is a block diagram of an occasion based recommendation module 110 according to one embodiment. The occasion based recommendation module 110 is configured for receiving, storing, retrieving and updating a plurality of occasion based food items for ordering in the food ordering system 100. In some embodiments, the food item listings may be accessed from a food item listing database 106.

The food item ordering module 202 is configured for receiving, storing, retrieving and updating a plurality of food order requests from exemplary food ordering users in the food ordering system 100.

The pre-booking slot generator 204 is configured for receiving, storing, retrieving and generating a plurality of time-limited pre-booking slots based on the selected significant day preference in the food ordering system 100.

The food item listings module 206 is configured for receiving, storing, retrieving and updating a plurality of food item listings from food establishments for ordering in the food ordering system 100. In some embodiments, the food item listings module 206 comprises all the details of the food item available at a particular time slot and specialty of the food establishment and its availability with respect to day of the week and time.

The food items list generator 208 is configured for receiving, storing, retrieving and generating a plurality of food item listings in the food ordering system 100. In other embodiments, the food items list generator 208 determines at least one food item based on the exemplary food ordering user preference and the significant day preference of the exemplary food ordering user from a database of plurality of food item listings.

The personal message preference module 210 is configured for receiving, storing, retrieving and updating a plurality of occasion-based personal message preferences to be sent with the pre-ordered food to exemplary food receiving users in the food ordering system 100.

The packaging selection preference module 212 is configured for receiving, storing, retrieving and updating a plurality of occasion-based packaging selection preferences to be sent with the pre-ordered food to exemplary food receiving users in the food ordering system 100.

The greeting card preference module 214 is configured for receiving, storing, retrieving and updating a plurality of occasion-based greeting card preferences to be sent with the pre-ordered food to exemplary food receiving users in the food ordering system 100.

The occasion based recommendation generator 216 is configured for receiving, storing, retrieving and generating a plurality of occasion-based food item recommendations in the food ordering system 100.

Although the occasion based recommendation module 110 is described as being composed of various modules, fewer or more modules (e.g., Occasion Based Reminder Module, Order Notification Module, Map Module, Live Tracking Module) may comprise the module with the present invention still falling within the scope of various embodiments.

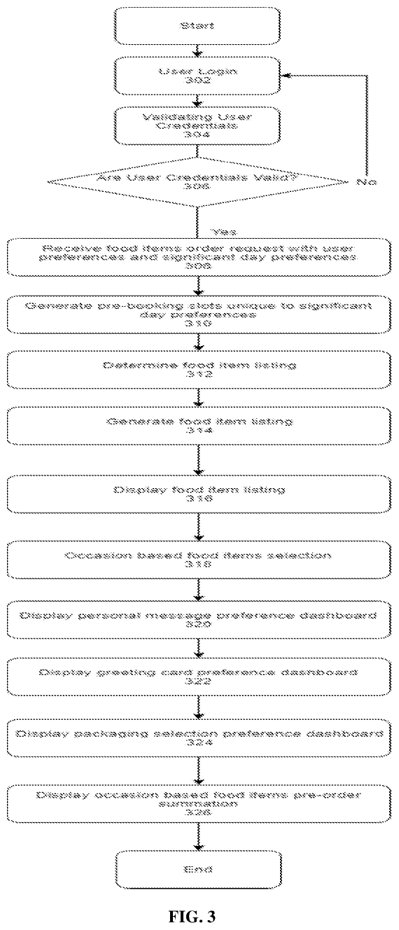

FIG. 3 is a flow diagram 300 of the method for pre-ordering occasion-based food items in a food ordering system 100 according to one embodiment. At step 302, an exemplary ordering user logs into the food ordering system using an associated electronic user device. At step 304, the user credentials of the exemplary ordering user are validated. At step 306, provided the user credentials are valid, the exemplary user is allowed access to the food ordering system 100. If the user credentials are not valid, the exemplary user is denied access to the food ordering system 100.

At step 308, the food item ordering module 202 receives a food order request from the exemplary ordering user along with user preferences and significant day preferences. At step 310, a set of unique pre-booking slots is generated by the pre-booking slot generator 204 based on the significant day preference, each such pre-booking slot being unique to each significant day. At step 312, the food item listings module 206 is used to determine at least one compatible occasion based food item listing from a plurality of food item listings based on the user preference and significant day preference. At step 314, the food items list generator 208 is used to generate occasion based food item listings based on the user preference and significant day preference. At step 316, the occasion based recommendation generator 216 is used to display a plurality of occasion based food items on the electronic device associated with the exemplary ordering user.

At step 318, a selection is made from the displayed list of occasion based food items. At step 320, the personal message preference dashboard is displayed via the personal message preference module 210. At step 322, the greeting card preference dashboard is displayed via the greeting card preference module 214. At step 324, the packaging selection preference dashboard is displayed via the packaging selection preference module 212. At step 326, a summation of the occasion based food items is displayed via the occasion based recommendation module 110.

Although the food ordering system 100 is described as being composed of various components like databases and modules, the food ordering system 100 may comprise fewer or more databases, components, and other modules. For example, the food ordering system 100 may include a Map Module, a Reply Preference Module, a Location Preference Module, a Reservation Preference Module, a Musical Greeting Preference Module, a Gift Voucher Module, with the present disclosure still falling within the scope of various embodiments. In some embodiments, an individual or group may play a plurality of user roles on the food ordering system, with the present disclosure still falling within the scope of various embodiments.

In various embodiments the food ordering system 100 may be any of a web application, a mobile application, or an embedded module or subsystem of a an online food ordering environment, a mobile food ordering environment, an electronic commerce system, an electronic payments system, a mobile operating system, a computer based operating system, or of a tablet based operating system, with the present disclosure still falling within the scope of various embodiments.

It is appreciated that, in some embodiments, various databases like 102, 104, 106, 108, modules 202, 204, 206, 208, 210, 212, 214, 216 as well as the databases, engines, modules and components of the above embodiments may be stored in the form of machine readable instructions in the memory of the food ordering system 100 and executed by a processor of the food ordering system 100 to perform one or more embodiments disclosed herein. Alternatively, the various databases like 102, 104, 106, 108, modules 202, 204, 206, 208, 210, 212, 214, 216 as well as the databases, engines, modules and components of the above embodiments may be implemented in the food ordering system 100 in the form of an apparatus configured to perform one or more embodiments disclosed herein.

The online food ordering system environment includes a food ordering system 100 according to one embodiment. The food ordering system 100 operates in the online food ordering system environment and communicates with a plurality of exemplary user devices over an exemplary network. The exemplary user devices are operated by a plurality of kinds of users in the online food ordering system environment. The exemplary user devices may comprise any of a variety of computing devices, such as but not limited to a desktop computer, a laptop, a mobile device, a tablet computer, a set-top box, a kiosk, interactive television, gaming console, and other computing platforms suitable for communicating with food ordering system 100. The food ordering system 100 provides a system for pre-ordering occasion based food items. The food ordering system 100 enables the various users to communicate and transact with other users in an online food ordering system environment and provide services to other users. The exemplary network includes a wireless area network, a local area network, a General Packet Radio Service (GPRS) network, an Enhanced Data for Global Evolution (EDGE) network and the like. The exemplary user devices are connected to the food ordering system 100 via the exemplary network.

The food ordering system 100 enables an exemplary ordering user to set user preferences and significant day preferences while pre-ordering occasion based food items.

Although the online food ordering system environment is described as being composed of various, user devices (e.g., personal computer), a network (e.g., internet, intranet, world wide web), it would be appreciated by one skilled in the art that fewer or more kinds of users, user devices (e.g., a mobile phone device, a portable gaming console device, a tablet device, a learning console device, gaming console device or server device attached to a television or other screen) and networks (e.g., an intranet at hospitality service providers, restaurants, fashion products ordering platforms, FMCG, groceries and essential products ordering platforms and local travel booking platforms may comprise the online food ordering system environment, with the present disclosure still falling within the scope of various embodiments.

Computing Machine Architecture

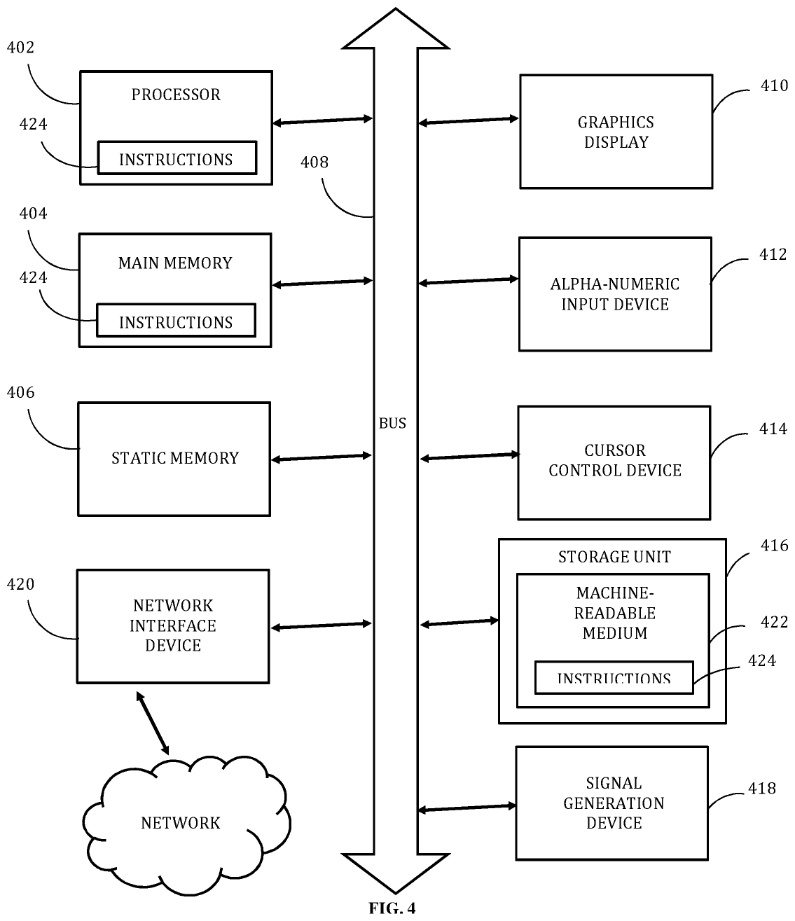

FIG. 4 is a block diagram illustrating modules of an example machine suitable for use as a food ordering system 100, in which any of the embodiments disclosed herein may be performed, according to one embodiment. This example machine is able to read instructions from a machine-readable medium and execute them in a processor (or controller).

Specifically, FIG. 4 shows a diagrammatic representation of a machine in the example form of a computer system 400 within which instructions 424 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 which carries out the computer-implemented method includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include a graphics display unit 410 (e.g., a plasma display panel (PDP), a liquid crystal display (LCD), a projector, or a cathode ray tube (CRT)). The computer system 400 may also include alphanumeric input device 412 (e.g., a keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over an exemplary network via the network interface device 420.

While machine readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

The food ordering system 100 may be one or more servers in which one or more methods disclosed herein are performed. The processor 402 may be a microprocessor, a state machine, an application specific integrated circuit, a field programmable gate array, etc. (e.g., Intel® Pentium® processor). The main memory 404 may be a dynamic random access memory and/or a primary memory of the food ordering system 100. The static memory 406 may be a hard drive, a flash drive, and/or other memory information associated with the food ordering system 100.

The bus 408 may be an interconnection between various circuits and/or structures of the food ordering system 100. The video display 410 may provide graphical representation of information on the food ordering system 100. The alphanumeric input device 412 may be a keypad, keyboard and/or any other input device. The cursor control device 414 may be a pointing device such as a mouse.

The storage unit 416 may be a hard drive, a storage system, and/or other longer term storage subsystem. The signal generation device 418 may be a bios and/or a functional operating system of the food ordering system 100. The network interface device 420 may be a device that may perform interface functions such as code conversion, protocol conversion and/or buffering required for communication to and from a network. The machine readable medium 422 may provide instructions 424 on which any of the methods disclosed herein may be performed. The instructions 424 may provide source code and/or data code to the processor 402 to enable any one/or more operations disclosed herein. For example, the food ordering system 100 may be stored in the form of instructions 424 on a storage medium such as the main memory 404 and/or the machine readable medium 422 such as compact disk.

In one embodiment, a non-transitory computer-readable storage medium having tangibly embodied thereon a program of instructions executable by a processor or a computing device (e.g., the food ordering system 100) causes the computing device to perform method steps illustrated in FIG. 3.

### Additional Configuration Considerations

Throughout this specification, plural instances may implement modules, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate modules in example configurations may be implemented as a combined structure or module. Similarly, structures and functionality presented as a single module may be implemented as separate modules. These and other variations, modifications, additions, and improvements fall within the scope of the subject matter herein.

Certain embodiments are described herein as including functionality implemented in computing logic or a number of components, modules, or mechanisms, for example, as illustrated in FIGS. 1, 2, and 3. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 402, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

In another embodiment, the occasion based food recommendation interface provided by the food ordering system 100 can be accessed over a local area network, intranet or virtual private network accessible to a limited plurality of user devices of hospitality service providers, restaurants, fashion products ordering platforms, FMCG, groceries and essential products ordering platforms and local travel booking platforms. through a user device.

In another embodiment, occasion based food recommendation interface provided by the food ordering system 100 can be accessed over a wide area network, General Packet Radio Service network, an Enhanced Data for Global Evolution network, a 3G telecommunications network, a 4G LTE telecommunications network or other telecommunications network through a user device.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although the present embodiments have been described with reference to specific example embodiments, it will be evident that various modifications and changes may be made to these embodiments without departing from the broader spirit and scope of the various embodiments. For example, the various devices, modules, databases, etc. described herein may be enabled and operated using hardware circuitry (e.g., complementary metal-oxide-semiconductor (CMOS) based logic circuitry), firmware, software and/or any combination of hardware, firmware, and/or software (e.g., embodied in a machine readable medium).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine modules that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and modules of the embodiments herein. This is done merely for convenience and to give a general sense of the invention. This description should be read to include one or at least one and the singular also includes the plural unless it is obvious that it is meant otherwise.

According to the embodiments described in FIG. 1 through 3, various methods and electric structures may be embodied using transistors, logic gates, and electrical circuits (e.g., Application Specific Integrated Circuitry and/or in Digital Signal Processor circuitry). For example, the occasion based recommendation module and other modules of FIGS. 1 to 3 may be enabled using a occasion based recommendation circuit and other circuits using one or more of the technologies described herein. In addition, it will be appreciated that the various operations, processes, and methods disclosed herein may be embodied in a machine-readable medium and/or a machine accessible medium compatible with a data processing system (e.g., a server) and may be performed in any order. Accordingly, the specification and drawings are to be regarded in an illustrative rather than a restrictive sense.

Upon reading this disclosure, those of skill in the art will appreciate still additional alternative structural and functional designs for a system and a process for pre-ordering occasion-based food items through the disclosed principles herein. Thus, while particular embodiments and applications have been illustrated and described, it is to be understood that the disclosed embodiments are not limited to the precise construction and modules disclosed herein. Various modifications, changes and variations, which will be apparent to those, skilled in the art, may be made in the arrangement, operation and details of the method and apparatus disclosed herein without departing from the spirit and scope defined in the appended claims.

1. A method for significant day-based pre-ordering of food items in a food ordering system, the system including one or more processors and a plurality of electronic user devices, the plurality of electronic user devices being remotely linked over a computer network through a network interface device configured to perform functions enabling communication to and from the computer network via a mobile or browser-based web application, a computer desktop application, an electronic module or subsystem of an online food ordering environment, a mobile environment, an electronic commerce system, an electronic payments system, a mobile application or an Internet-based website, each of the plurality of user computing devices including an electronic user interface and an electronic display, the one or more processors configured with one or more computer-implemented modules or generators including an occasion based recommendation module, a graphic display module, a food item ordering module, a pre-booking slot generator, a food item listings module, a food items list generator, a personal message preference module, a packaging selection preference module, a greeting card preference module, a user database, a food vendor database, a food list database, and a significant day database, the method comprising:
receiving, via the food item ordering module, a food order request from an electronic user device associated with at least one ordering user, wherein the food order request comprises at least one user preference and at least one significant day preference;
generating, via the pre-booking slot generator, a set of unique time-limited pre-booking slots based on the at least one significant day preference in the food order request;
determining, via the food item listings module, at least one food item listing based on the user preference and the significant day preference of the ordering user from a plurality of food item listings predefined in the food ordering system;
generating, via the food items list generator, at least one food items list, each such list comprising at least one food item which is available during the time-limited pre-booking slots based on the user preference and the significant day preference of the ordering user; and
displaying, via the occasion based recommendation generator, a plurality of compatible occasion based food items on the electronic device associated with the ordering user, based on the user preference and significant day preference.

2. The method of claim 1, wherein the step of determining at least one food item listing further comprises, displaying, via a personal message preference module, a dashboard comprising at least one personal message preference for the receiving user on the electronic user device associated with the ordering user.

3. The method of claim 1, wherein the step of determining at least one food item listing further comprises, displaying, via the greeting card preference module, at least one greeting card preference on the electronic user device associated with the ordering user.

4. The method of claim 1, the step of determining at least one food item listing further comprises, displaying, via the packaging selection preference module, at least one packaging selection on the electronic device associated with the ordering user for packaging the occasion based food items.

5. The method of claim 1, wherein the food order request includes at least one receiving user's name, at least one food order delivery address of the receiving user, at least one food order delivery date and at least one food order delivery time.

6. A non-transitory computer readable storage medium having tangibly embodied thereon a program of instructions executable by a processor for significant day-based pre-ordering of food items in an online food ordering system, the system including one or more processors and a plurality of electronic user devices, the plurality of electronic user devices being remotely linked over a computer network through a network interface device configured to perform functions enabling communication to and from the computer network via a mobile or browser-based web application, a computer desktop application, an electronic module or subsystem of an online food ordering environment, a mobile environment, an electronic commerce system, an electronic payments system, a mobile application or an Internet-based website, each of the plurality of user computing devices including an electronic user interface and an electronic display, the one or more processors configured with one or more computer-implemented modules or generators including an occasion based recommendation module, a graphic display module, a food item ordering module, a pre-booking slot generator, a food item listings module, a food items list generator, a personal message preference module, a packaging selection preference module, a greeting card preference module, a user database, a food vendor database, a food list database, and a significant day database, instructions when executed causing the processor to perform steps of:
receiving, via the food item ordering module, a food order request from an electronic user device associated with at least one ordering user, wherein the food order request comprises at least one user preference and at least one significant day preference;
generating, via the pre-booking slot generator, a set of unique time-limited pre-booking slots based on the at least one significant day preference in the food order request;
determining, via the food item listings module, at least one food item listing based on the user preference and the significant day preference of the ordering user from a plurality of food item listings predefined in the food ordering system;
generating, via the food items list generator, at least one food items list, each such list comprising at least one food item which is available during the time-limited pre-booking slots based on the user preference and the significant day preference of the ordering user; and
displaying, via the occasion based recommendation generator, a plurality of compatible occasion based food items on the electronic device associated with the ordering user, based on the user preference and significant day preference.

7. The non-transitory computer readable storage medium of claim 6, wherein the step of determining at least one food item listing executed by instructions further comprises, displaying, via a personal message preference module, a dashboard comprising at least one personal message preference for the receiving user on the electronic user device associated with the ordering user.

8. The non-transitory computer readable storage medium of claim 6, wherein the step of determining at least one food item listing executed by instructions further comprises, displaying, via the greeting card preference module, at least one greeting card preference on the electronic user device associated with the ordering user.

9. The non-transitory computer readable storage medium of claim 6, wherein the step of determining at least one food item listing executed by instructions further comprises, displaying, via the packaging selection preference module, at least one packaging selection on the electronic device associated with the ordering user for packaging the occasion based food items.

10. The non-transitory computer readable storage medium of claim 6, wherein the food order request includes at least one receiving user's name, at least one food order delivery address of the receiving user, at least one food order delivery date and at least one food order delivery time.

11. An apparatus comprising:
a network interface configured for significant day-based pre-ordering of food items in a food ordering system;
a processor coupled to the network interface;
a memory coupled to the processor, wherein the memory comprises instructions for execution on the processor to perform steps of:
receiving, via the food item ordering module, a food order request from an electronic user device associated with at least one ordering user, wherein the food order request comprises at least one user preference and at least one significant day preference;
generating, via the pre-booking slot generator, a set of unique time-limited pre-booking slots based on the at least one significant day preference in the food order request;
determining, via the food item listings module, at least one food item listing based on the user preference and the significant day preference of the ordering user from a plurality of food item listings predefined in the food ordering system;
generating, via the food items list generator, at least one food items list, each such list comprising at least one food item which is available during the time-limited pre-booking slots based on the user preference and the significant day preference of the ordering user; and
displaying, via the occasion based recommendation generator, a plurality of compatible occasion based food items on the electronic device associated with the ordering user, based on the user preference and significant day preference.

12. The apparatus of claim 11, wherein the step of determining at least one food item listing executed by instructions further comprises, displaying, via a personal message preference module, a dashboard comprising at least one personal message preference for the receiving user on the electronic user device associated with the ordering user.

13. The apparatus of claim 11, wherein the step of determining at least one food item listing executed by instructions further comprises, displaying, via the greeting card preference module, at least one greeting card preference on the electronic user device associated with the ordering user.

14. The apparatus of claim 11, wherein the step of determining at least one food item listing executed by instructions further comprises, displaying, via the packaging selection preference module, at least one packaging selection on the electronic device associated with the ordering user for packaging the occasion based food items.

15. The apparatus of claim 11, wherein the food order request includes at least one receiving user's name, at least one food order delivery address of the receiving user, at least one food order delivery date and at least one food order delivery time.
